(19) United States
(12) Patent Application Publication
(10) Pub. No.: US 2025/0202135 A1
(43) Pub. Date: Jun. 19, 2025

(54) INSULATION DISPLACEMENT CONNECTOR

(71) Applicant: Japan Aviation Electronics Industry, Ltd., Tokyo (JP)

(72) Inventor: Kenta Ashibu, Tokyo (JP)

(73) Assignee: Japan Aviation Electronics Industry, Ltd., Tokyo (JP)

(21) Appl. No.: 18/925,736

(22) Filed: Oct. 24, 2024

(30) Foreign Application Priority Data
Dec. 18, 2023 (JP) 2023-212920

(51) Int. Cl. H01R 4/2425; H01R 4/2445

(52) U.S. Cl. CPC H01R 4/2425; H01R 4/2445

(57) ABSTRACT

An insulation displacement connector includes an insulation displacement contact and a twisting member. The insulation displacement contact includes a base and a pair of insulation displacement pieces extending from the base. A wire is press-fit into a wire press-fit slot formed between the pair of insulation displacement pieces, and thereby a core wire of the wire comes into contact with the pair of insulation displacement pieces. The twisting member mates with the insulation displacement contact and thereby twists the wire so that the orientation of a line segment changes when viewed from above.

### INCORPORATION BY REFERENCE

This application is based upon and claims the benefit of priority from Japanese patent application No. 2023-212920, filed on Dec. 18, 2023, the disclosure of which is incorporated herein in its entirety by reference.

### BACKGROUND

The present disclosure relates to an insulation displacement connector.

As shown in FIG. 12 of the present application, Patent Literature 1 (Japanese Unexamined Patent Application Publication No. 2011-29125) discloses an insulation displacement connector 104 that includes an insulation displacement contact (IDC) 102 where a wire 101 is press-fit between a pair of IDC blades 100 and a compressing member 103 in a cylindrical shape that pushes the pair of IDC blades 100 so that the pair of IDC blades 100 come closer to each other. To be specific, when the pair of IDC blades 100 of the insulation displacement contact 102 mate with a mating space 105 of the compressing member 103, the wire 101 is press-fit into a slot 106 between the pair of IDC blades 100. A covering 107 of the wire 101 is thereby cut by the pair of the pair of IDC blades 100. This cutting causes a core wire 108 of the wire 101 to be exposed, and the exposed core wire 108 comes into contact with the pair of IDC blades 100. Further, by this mating, the pair of IDC blades 100 are pushed by the compressing member 103 so as to come closer to each other and thereby the slot 106 is narrowed, and consequently an oxide layer formed on the core wire 108 of the wire 101 is removed.

### SUMMARY

In the above-described Patent Literature 1, room for improvement remains in terms of contact reliability.

An object of the present disclosure is to provide an insulation displacement connector with high contact reliability.

There is provided an insulation displacement connector including an insulation displacement contact including a base and a pair of insulation displacement pieces extending from the base, where a wire is press-fit into a slot formed between the pair of insulation displacement pieces and thereby a core wire of the wire comes into contact with the pair of insulation displacement pieces, and a twisting member configured to mate with the insulation displacement contact and thereby twist the wire so that a longitudinal direction of the core wire of the wire changes when viewed along a press-fit direction of press-fitting the wire into the slot of the insulation displacement contact.

According to the present disclosure, an insulation displacement connector with high contact reliability is achieved.

The above and other objects, features and advantages of the present disclosure will become more fully understood from the detailed description given hereinbelow and the accompanying drawings.

### BRIEF DESCRIPTION OF DRAWINGS

FIG. 1 is a perspective view of an insulation displacement connector before mating;

FIG. 2 is a front view of an insulation displacement contact before a wire is press-fit thereinto;

FIG. 3 is a front view of the insulation displacement contact after a wire is press-fit thereinto;

FIG. 4 is a perspective view showing the mating state of the insulation displacement connector;

FIG. 5 is a perspective view of a twisting member;

FIG. 6 is a perspective view showing the mating state of the insulation displacement connector;

FIG. 7 is a plan view showing the mating state of the insulation displacement connector;

FIG. 8 is a plan sectional view of the insulation displacement contact after a wire is press-fit thereinto;

FIG. 9 is a plan sectional view showing the mating state of the insulation displacement connector;

FIG. 10 is a partial plan view of the insulation displacement connector when the insulation displacement contact is deformed by stress relaxation;

FIG. 11 is a plan sectional view of the insulation displacement connector when the insulation displacement contact is deformed by stress relaxation; and

FIG. 12 is a view showing a simplified version of FIG. 4 of Patent Literature 1.

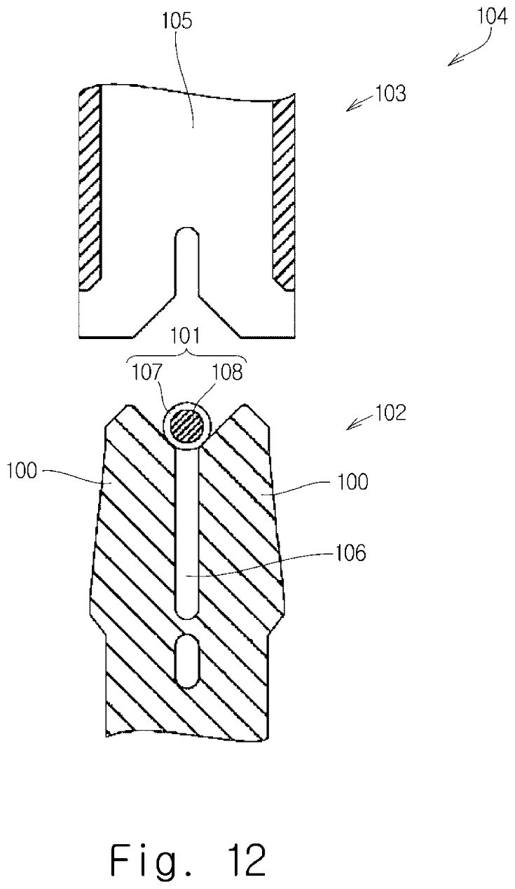

### DESCRIPTION OF EMBODIMENTS

Although the present disclosure will be described hereinafter through an embodiment of the disclosure, the disclosure defined by the scope of claims is not limited to the following embodiment. Further, not all of the elements described in the embodiment are essential as a solution to problem. The following description and the drawings are appropriately shortened and simplified to clarify the explanation. In the drawings, the identical reference symbols denote identical structural elements and the redundant explanation thereof is omitted according to need.

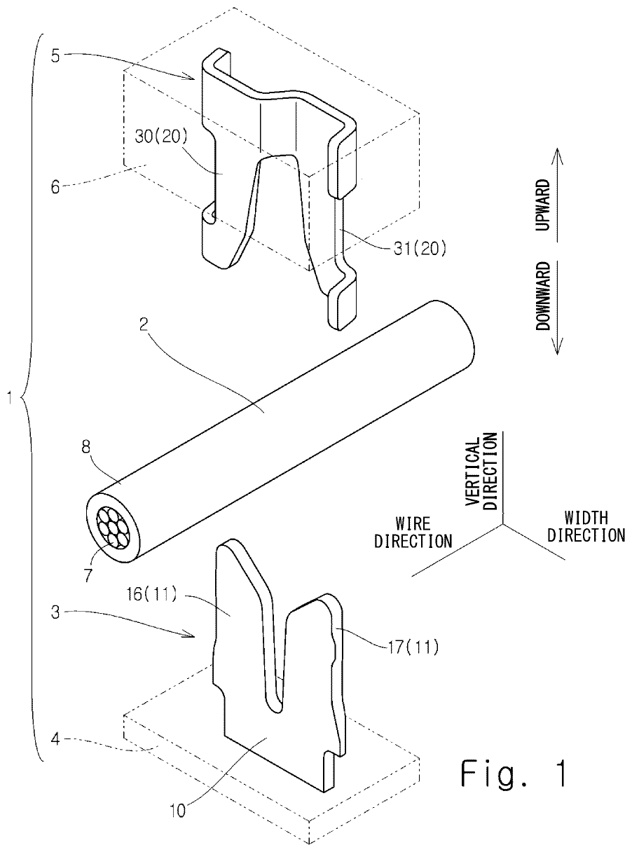

FIG. 1 is a perspective view of an insulation displacement connector 1 and a wire 2. As shown in FIG. 1, the insulation displacement connector 1 includes an insulation displacement contact 3, an insulation displacement contact-side housing 4 that holds the insulation displacement contact 3, a twisting member 5, and a twisting member-side housing 6 that holds the twisting member 5. In FIG. 1, the insulation displacement contact-side housing 4 and the twisting member-side housing 6 are shown by chain double-dashed lines. The insulation displacement contact 3 and the twisting member 5 are held by the insulation displacement contact-side housing 4 and the twisting member-side housing 6, respectively, typically by press fitting or insert molding. The insulation displacement contact 3 and the twisting member 5 are formed typically by pressing a sheet metal such as copper and copper alloy. The insulation displacement contact-side housing 4 and the twisting member-side housing 6 are formed typically by injection molding an insulating resin such as PBT (Polybutylene terephthalate), PPS (Poly Phenylene Sulfide), nylon resin, and LCP (Liquid Crystal Polymer; registered trademark). The insulation displacement contact-side housing 4 and the twisting member-side housing 6 can be omitted.

### <Wire 2>

The wire 2 includes a core wire 7 and an insulative covering 8 that covers the core wire 7. The core wire 7 is typically a stranded wire made of copper, copper alloy, aluminum, aluminum alloy or the like.

### <Insulation Displacement Contact 3>

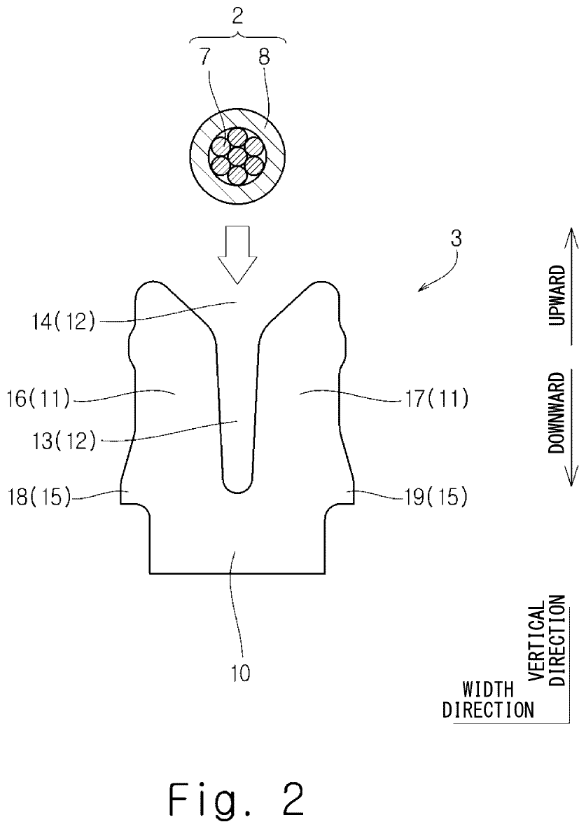

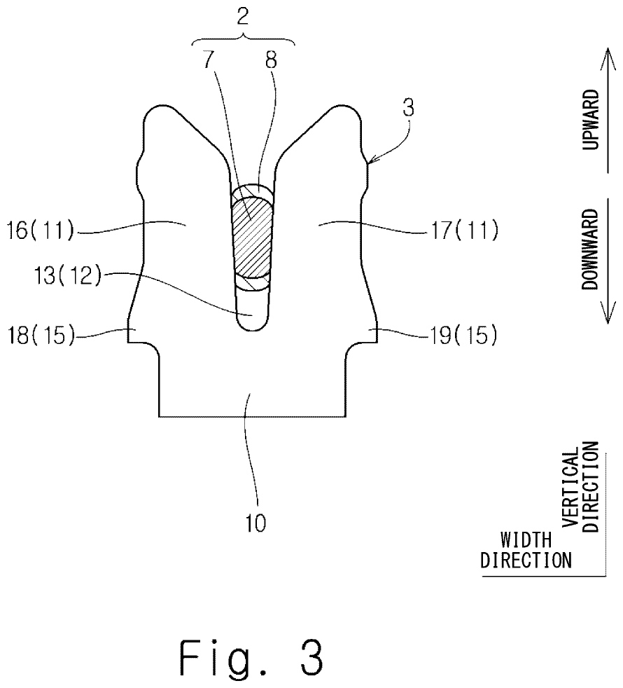

FIGS. 2 and 3 show press-fitting the wire 2 into the insulation displacement contact 3. As shown in FIGS. 1 to 3, the insulation displacement contact 3 is typically in flat plate shape. The insulation displacement contact 3 includes a base 10 that is held by the insulation displacement contact-side housing 4 and a pair of insulation displacement pieces (IDC pieces) 11 that extend from the base 10.

The pair of IDC pieces 11 extend in the same direction from the base 10. The pair of IDC pieces 11 are disposed apart from each other. Thus, a wire press-fit slot 12 is formed between the pair of IDC pieces 11. As shown in FIGS. 2 and 3, the wire 2 is press-fit into the wire press-fit slot 12 by using a jig, which is not shown, and thereby the covering 8 of the wire 2 is cut by the pair of IDC pieces 11, and the exposed core wire 7 comes into electrical contact with the pair of IDC pieces 11. As shown in FIG. 3, as the core wire 7 is press-fit into the wire press-fit slot 12, it is crushed in the direction where the pair of IDC pieces 11 are opposed to each other. Note that, although the core wire 7 is still a stranded wire after crushed, it is shown as a single wire in FIG. 3 for the sake of convenience. In the state where the wire 2 is press-fit into the insulation displacement contact 3, the wire 2 extends in the thickness direction of the insulation displacement contact 3.

Referring to FIGS. 1 to 3, a wire direction, a width direction, and a vertical direction are defined as follows. The wire direction, the width direction, and the vertical direction are orthogonal to one another. The wire direction is a longitudinal direction of the wire 2 that is press-fit into the insulation displacement contact 3. Since the longitudinal direction of the wire 2 coincides with the thickness direction of the insulation displacement contact 3, the wire direction corresponds to the thickness direction of the insulation displacement contact 3. The width direction is a direction where the pair of IDC pieces 11 are opposed to each other. The width direction includes inward in the width direction and outward in the width direction. A direction that is inward in the width direction is a direction of viewing the wire press-fit slot 12 from the pair of IDC pieces 11. A direction that is outward in the width direction is a direction of viewing the pair of IDC pieces 11 from the wire press-fit slot 12. The vertical direction includes downward, which is a press-fit direction of press-fitting the wire 2 into the insulation displacement contact 3, and upward, which is the opposite direction thereto. Note that the wire direction, the width direction, and the vertical direction are directions that are defined by way of illustration only, and those terms should not be interpreted as limiting the position of the insulation displacement connector 1 when actually used.

Referring further to FIG. 2, the insulation displacement contact 3 is described hereinafter. As shown in FIG. 2, the wire press-fit slot 12 is formed to get wider toward the top. To be specific, the wire press-fit slot 12 includes a wire accommodation part 13 and a wire guide part 14. The wire accommodation part 13 and the wire guide part 14 are located in this recited order from bottom to top. The wire accommodation part 13 accommodates the wire 2 that is press-fit into the insulation displacement contact 3. The wire guide part 14 guides the wire 2 to the wire accommodation part 13. Thus, while the wire accommodation part 13 is formed to get slightly wider toward the top, the wire guide part 14 is formed to get significantly wider toward the top.

The insulation displacement contact 3 further includes a pair of contact-side lock parts 15. The pair of contact-side lock parts 15 are respectively formed to project outward in the width direction from the root of the pair of IDC pieces 11.

For convenience of description, the pair of IDC pieces 11 are referred to hereinafter as a first IDC piece 16 and a second IDC piece 17 in some cases. Further, the pair of contact-side lock parts 15 are referred to hereinafter as a first contact-side lock part 18 and a second contact-side lock part 19 in some cases. As shown in FIG. 2, the first IDC piece 16 and the first contact-side lock part 18 are disposed on one side when viewed from the wire press-fit slot 12, and the second IDC piece 17 and the second contact-side lock part 19 are disposed on the other side when viewed from the wire press-fit slot 12.

### <Twisting Member 5>

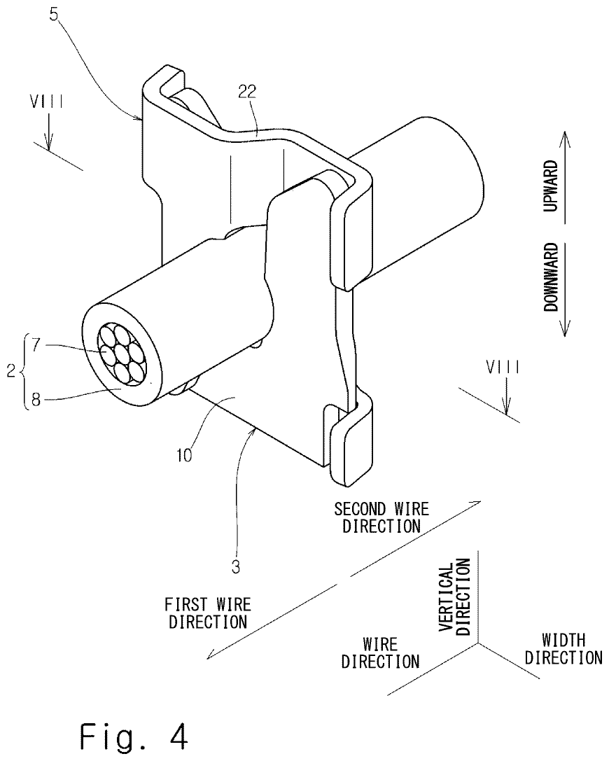

Referring back to FIG. 1, the twisting member 5 is used to improve the contact reliability between the core wire 7 of the wire 2 and the insulation displacement contact 3. FIG. 4 shows the state where the twisting member 5 mates with the insulation displacement contact 3 into which the wire 2 is press-fit. As shown in FIGS. 1 and 4, the twisting member 5 moves downward relatively toward the insulation displacement contact 3 and thereby mates with the insulation displacement contact 3. The twisting member 5 mates with the insulation displacement contact 3 in this manner, which improves the contact reliability between the core wire 7 of the wire 2 and the insulation displacement contact 3. In the state where the twisting member 5 mates with the insulation displacement contact 3, the position of the twisting member 5 with respect to the insulation displacement contact 3 is uniquely determined. Thus, in the following description of the twisting member 5, the wire direction, the width direction, and the vertical direction defined earlier in the description of the insulation displacement contact 3 are used in the same way.

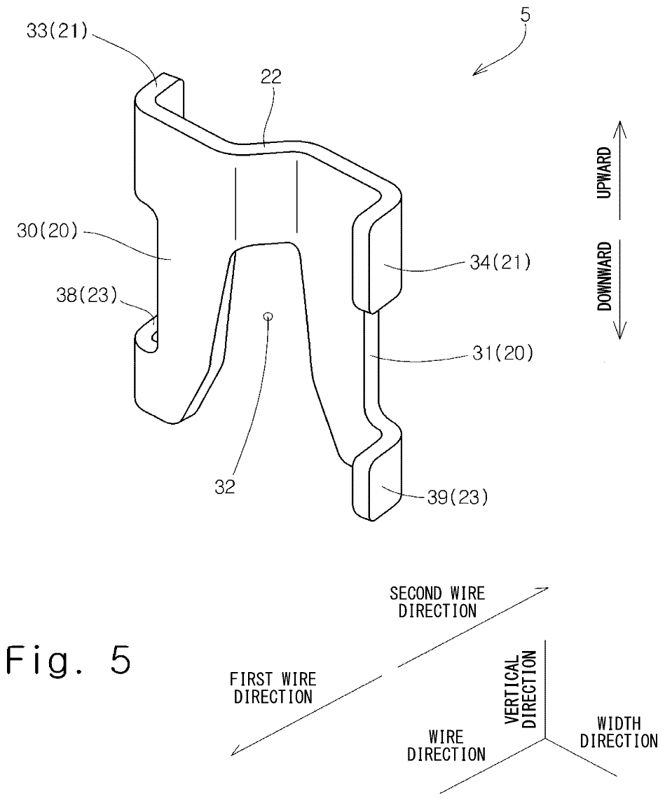

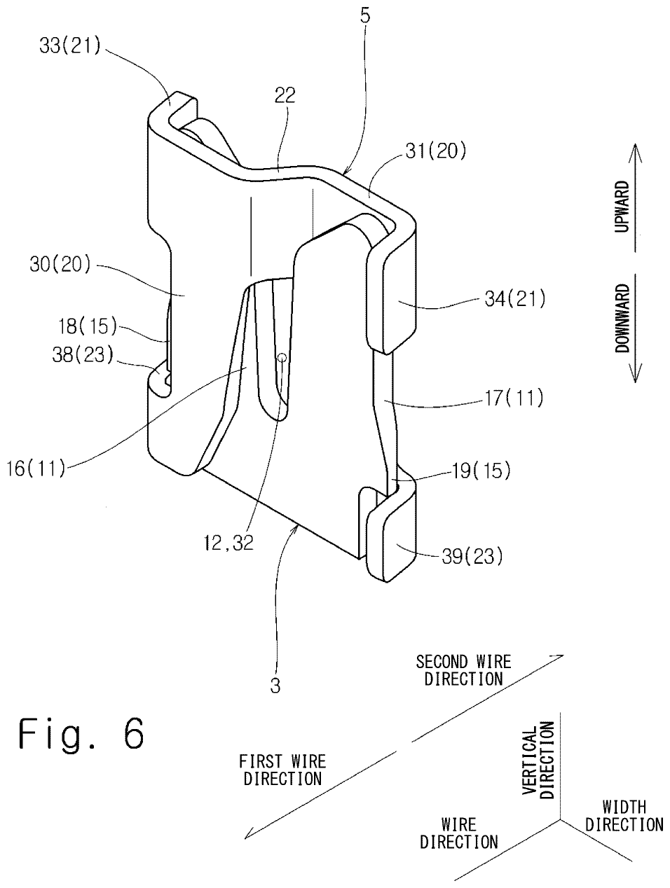

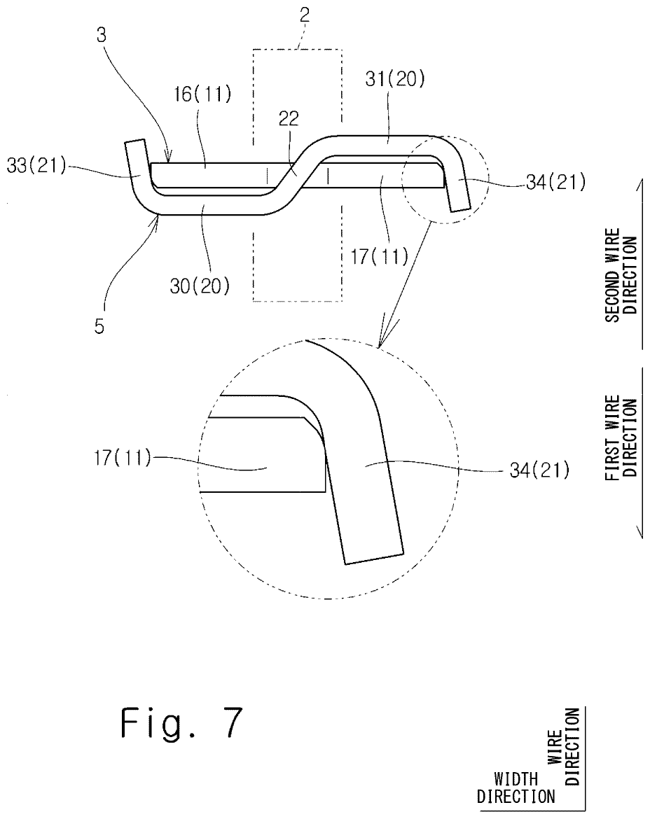

FIG. 5 is a perspective view of the twisting member 5. FIG. 6 is a perspective view of the twisting member 5 that mates with the insulation displacement contact 3. Note that, in FIG. 6, the wire 2 is not illustrated for convenience of description. FIG. 7 is a plan view of the twisting member 5 that mates with the insulation displacement contact 3. Note that, in FIG. 7, the wire 2 is shown in a simplified manner with chain double-dashed lines for convenience of description.

As shown in FIGS. 5 to 7, the twisting member 5 is formed in S shape when viewed from above. To be specific, the twisting member 5 includes a pair of covering contact pieces 20, a pair of pushing parts 21, a coupling part 22, and a pair of member-side lock parts 23.

As shown in FIG. 5, the pair of covering contact pieces 20 extend in the vertical direction. The pair of covering contact pieces 20 are apart from each other in the width direction. The thickness direction of the pair of covering contact pieces 20 coincides with the wire direction. The pair of covering contact pieces 20 are slightly out of alignment in the wire direction. A first wire direction and a second wire direction are defined as follows with reference to FIGS. 5 and 6. The first wire direction and the second wire direction are directions parallel to the wire direction and opposite to each other. Thus, the first wire direction and the second wire direction can be referred to also as a first wire orientation and a second wire orientation, respectively. The pair of covering contact pieces 20 include a first covering contact piece 30 and a second covering contact piece 31. When observing the twisting member 5 along the width direction, the first covering contact piece 30 and the second covering contact piece 31 are disposed in this recited order along the second wire direction. Thus, when observing the twisting member 5 along the width direction, the second wire direction is a direction of viewing the second covering contact piece 31 from the covering contact piece 30. The pair of covering contact pieces 20 are coupled with each other through the coupling part 22. In more detail, the coupling part 22 couples the upper ends of the pair of covering contact pieces 20. Thus, the twisting member 5 has a wire accommodation slot 32 that is defined by the pair of covering contact pieces 20 in the wire direction, defined by the coupling part 22 in the vertical direction, and opens downward. The wire accommodation slot 32 is formed to get slightly wider toward the bottom. As shown in FIGS. 6 and 7, the first covering contact piece 30 and the second covering contact piece 31 are opposed to the first IDC piece 16 and the second IDC piece 17, respectively, in the wire direction.

The pair of pushing parts 21 are formed to project in the wire direction from the upper ends of the pair of covering contact pieces 20. The pair of pushing parts 21 include a first pushing part 33 and a second pushing part 34.

As shown in FIGS. 6 and 7, the first pushing part 33 projects in the second wire direction from the upper end of the first covering contact piece 30 at its outward end in the width direction. As shown in FIG. 7, the first pushing part 33 projects to be slightly inclined outward in the width direction relative to the wire direction as it goes toward the second wire direction. Thus, the first pushing part 33 can be referred to as projecting to be apart from the wire 2.

As shown in FIGS. 6 and 7, the second pushing part 34 projects in the first wire direction from the upper end of the second covering contact piece 31 at its outward end in the width direction. As shown in FIG. 7, the second pushing part 34 projects to be slightly inclined outward in the width direction relative to the wire direction as it goes toward the first wire direction. Thus, the second pushing part 34 can be referred to as projecting to be apart from the wire 2.

Therefore, as shown in FIG. 7, the pair of covering contact pieces 20, the pair of pushing parts 21, and the coupling part 22 form an S-shape when viewed from above as described earlier. The first pushing part 33, the first covering contact piece 30, the coupling part 22, the second covering contact piece 31, and the second pushing part 34 are linked together in this recited order.

Referring still to FIG. 7, in the state where the twisting member 5 mates with the insulation displacement contact 3, the pair of pushing parts 21 are opposed to the pair of IDC pieces 11 in the width direction. To be specific, the first pushing part 33 and the second pushing part 34 are disposed outward in the width direction relative to the first IDC piece 16 and the second IDC piece 17, respectively. In the state where the twisting member 5 mates with the insulation displacement contact 3, the first pushing part 33 and the second pushing part 34 are in contact with the first IDC piece 16 and the second IDC piece 17, respectively, in the width direction. In the state where the twisting member 5 mates with the insulation displacement contact 3, the first pushing part 33 and the second pushing part 34 push the first IDC piece 16 and the second IDC piece 17, respectively, in the width direction by the elastic restoring force of the twisting member 5 so that the first IDC piece 16 and the second IDC piece 17 come closer to each other. In other words, the first pushing part 33 and the second pushing part 34 push the first IDC piece 16 and the second IDC piece 17, respectively, inward in the width direction by the elastic restoring force of the twisting member 5. This pushing enhances the contact pressure of the core wire 7 of the wire 2 on the pair of IDC pieces 11.

Referring to FIGS. 5 and 6, the pair of member-side lock parts 23 are formed to project in the wire direction from the lower ends of the pair of covering contact pieces 20, respectively. The pair of member-side lock parts 23 include a first member-side lock part 38 and a second member-side lock part 39. The first member-side lock part 38 projects in the second wire direction from the lower end of the first covering contact piece 30 at its outward end in the width direction. The second member-side lock part 39 projects in the first wire direction from the lower end of the second covering contact piece 31 at its outward end in the width direction.

As shown in FIG. 6, in the state where the twisting member 5 mates with the insulation displacement contact 3, the first member-side lock part 38 is opposed to the first contact-side lock part 18 in the vertical direction, and it is located down below the first contact-side lock part 18. Likewise, the second member-side lock part 39 is opposed to the second contact-side lock part 19 in the vertical direction, and it is located down below the second contact-side lock part 19. This restricts the twisting member 5 from moving upward relative to the insulation displacement contact 3 in the state where the twisting member 5 mates with the insulation displacement contact 3, so that mating of the twisting member 5 and the insulation displacement contact 3 is locked.

### <Press-Fit>

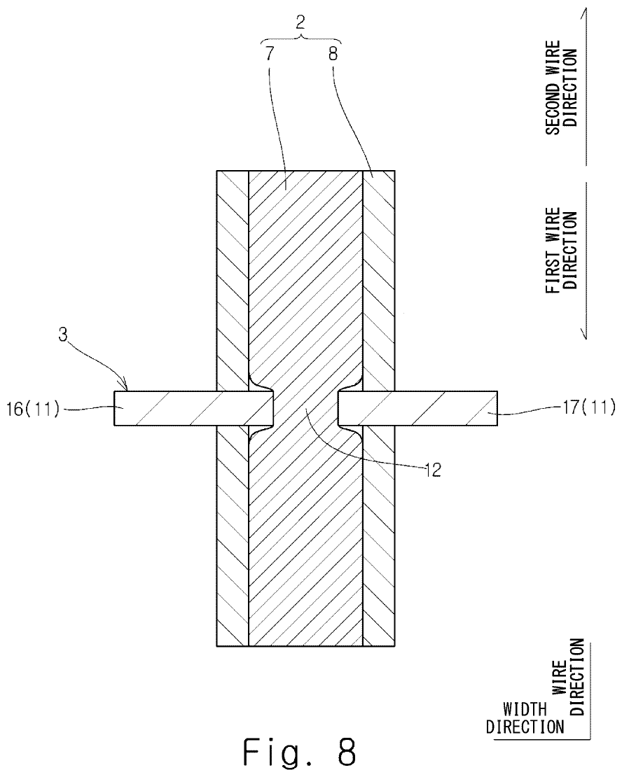

Press-fitting the wire 2 into the insulation displacement contact 3 is described hereinafter in detail. As shown in FIGS. 2 and 3, if the wire 2 is press-fit into the wire press-fit slot 12 of the insulation displacement contact 3, the wire 2 is compressed in the width direction as shown in FIGS. 3 and 8. As shown in FIG. 8, the covering 8 of the wire 2 is cut by contact with the pair of IDC pieces 11, and thereby the core wire 7 of the wire 2 is exposed in the width direction. As a result, the exposed core wire 7 comes into electrical contact with the pair of IDC pieces 11 with a certain contact pressure.

### <Mating>

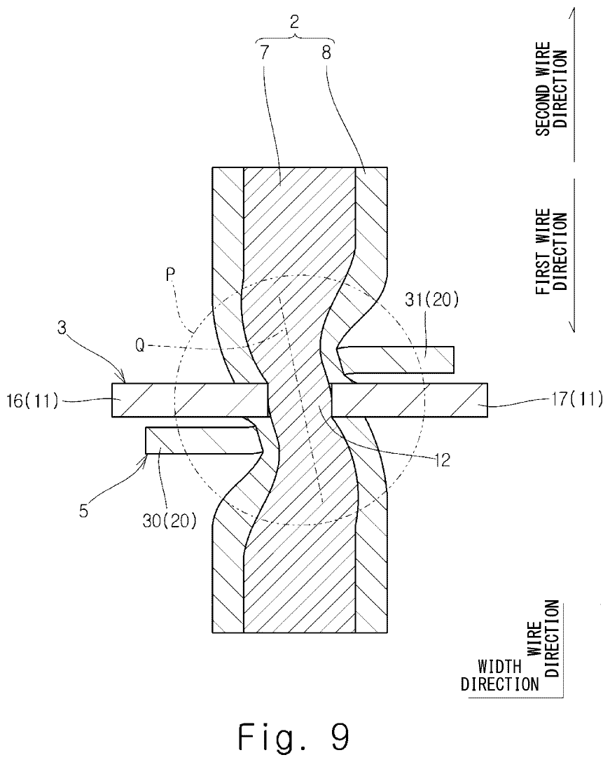

Mating the twisting member 5 with the insulation displacement contact 3 is described hereinafter in detail. As shown in FIGS. 1 and 4, to mate the twisting member 5 with the insulation displacement contact 3, in the state where the insulation displacement contact 3 and the twisting member 5 are opposed to each other in the vertical direction, the twisting member 5 is displaced downward relatively toward the insulation displacement contact 3. In this step, as shown in FIG. 9, the mating positional relation of the insulation displacement contact 3 and the twisting member 5 is such that the pair of covering contact pieces 20 of the twisting member 5 are disposed on opposite sides to each other with the insulation displacement contact 3 interposed therebetween and also disposed on opposite sides to each other with the wire 2 interposed therebetween when viewed from above.

If, maintaining the above-described mating positional relation, the twisting member 5 is further displaced downward relatively toward the insulation displacement contact 3, first, as shown in FIG. 6, the first member-side lock part 38 and the second member-side lock part 39 climb over the first contact-side lock part 18 and the second contact-side lock part 19, respectively, so that the twisting member 5 mates with the insulation displacement contact 3. To be specific, the first member-side lock part 38 comes into contact with the first contact-side lock part 18 and thereby the first member-side lock part 38 is elastically displaced outward in the width direction as the first covering contact piece 30 is twisted and deformed, and after the first member-side lock part 38 climbs over the first contact-side lock part 18, the first member-side lock part 38 is elastically restored inward in the width direction by the elastic restoring force of the first covering contact piece 30. Consequently, the first contact-side lock part 18 and the first member-side lock part 38 are aligned in this recited order from top to bottom, and the first contact-side lock part 18 and the first member-side lock part 38 are opposed to each other in the vertical direction. The same applies to the second member-side lock part 39 and the second contact-side lock part 19. Mating the twisting member 5 with the insulation displacement contact 3 means establishing the above-described positional relation of the first contact-side lock part 18, the second contact-side lock part 19, the first member-side lock part 38, and the second member-side lock part 39. This positional relation restricts the twisting member 5 from moving upward relative to the insulation displacement contact 3, so that mating of the insulation displacement contact 3 and the twisting member 5 is locked.

Second, as shown in FIG. 4, the coupling part 22 of the twisting member 5 is opposed to the wire 2 in the vertical direction. This prevents the wire 2 that is press-fit into the insulation displacement contact 3 from being pulled out upward. Note that, in the mating state shown in FIG. 4, the coupling part 22 of the twisting member 5 is typically not in contact with the covering 8 of the wire 2 in the vertical direction. However, in the above-described mating state, the coupling part 22 of the twisting member 5 may be in contact with the covering 8 of the wire 2 in the vertical direction.

Third, as shown in FIG. 7, the pair of IDC pieces 11 come into contact with the pair of pushing parts 21, respectively, in the width direction, and thereby an inward force in the width direction acts on the pair of IDC pieces 11. This increases the contact pressure of the core wire 7 of the wire 2 on the pair of IDC pieces 11, which improves the contact reliability between the core wire 7 of the wire 2 and the insulation displacement contact 3. Note that, at this moment, the pair of pushing parts 21 are slightly elastically displaced outward in the width direction with elastic displacement of the pair of covering contact pieces 20 and the coupling part 22, thereby absorbing a certain degree of dimensional error during manufacture. This prevents an excessive inward force in the width direction from acting on the pair of IDC pieces 11 when the pair of IDC pieces 11 come into contact with the pair of pushing parts 21, respectively, in the width direction, which protects the core wire 7 from damage.

Fourth, as shown in FIG. 9, the first covering contact piece 30 and the second covering contact piece 31 are pushed inward in the width direction against the covering 8 of the wire 2. As described earlier, the first covering contact piece 30 and the second covering contact piece 31 are disposed on opposite sides to each other with the insulation displacement contact 3 interposed therebetween and also disposed on opposite sides to each other with the wire 2 interposed therebetween when viewed from above in FIG. 9. Thus, as the first covering contact piece 30 and the second covering contact piece 31 are pushed inward in the width direction against the covering 8 of the wire 2 as described above, a couple acts on the wire 2. Consequently, the wire 2 is twisted locally counter-clockwise in a proximity area P of the wire press-fit slot 12 of the insulation displacement contact 3. The longitudinal direction of the wire 2 in the proximity area P is shown by a line segment Q. As shown in FIG. 9, the line segment Q is inclined counter-clockwise relative to the wire direction when viewed from above. This inclination locally significantly increases the contact pressure of the core wire 7 of the wire 2 on the first IDC piece 16. Likewise, this inclination locally significantly increases the contact pressure of the core wire 7 of the wire 2 on the second IDC piece 17. As a result, the maximum value of the contact pressure of the core wire 7 of the wire 2 on the insulation displacement contact 3 is higher than that before mating, which achieves high contact reliability between the wire 2 and the insulation displacement contact 3.

### <Stress Relaxation>

Stress relaxation in the insulation displacement contact 3 is described hereinafter. As shown in FIGS. 8 and 9, in the state where the wire 2 is press-fit into the insulation displacement contact 3, an outward stress in the width direction is acting on the pair of IDC pieces 11. Thus, the pair of IDC pieces 11 are to be gradually displaced outward in the width direction so that the stress on the pair of IDC pieces 11 is relaxed. This phenomenon is called stress relaxation phenomenon, and significantly appears particularly when the insulation displacement contact 3 is exposed to high temperature. In this manner, when the pair of IDC pieces 11 are displaced outward in the width direction, the contact pressure of the core wire 7 of the wire 2 on the pair of IDC pieces 11 decreases, which can hinder the contact reliability between the wire 2 and the insulation displacement contact 3. As shown in FIG. 7, displacement of the pair of IDC pieces 11 outward in the width direction by stress relaxation is prevented to a certain degree by the rigidity of the twisting member 5 as the pair of IDC pieces 11 are in contact with the pair of pushing parts 21 in the width direction.

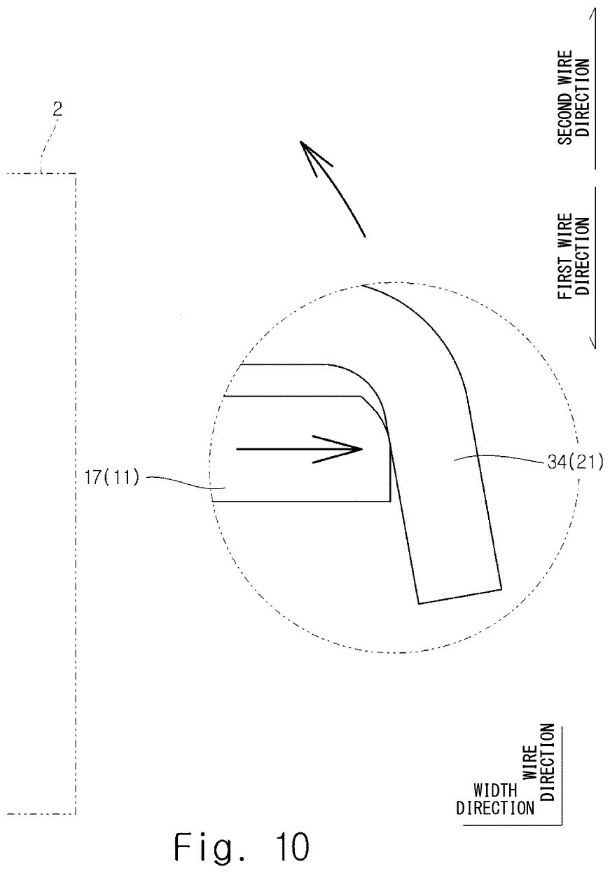

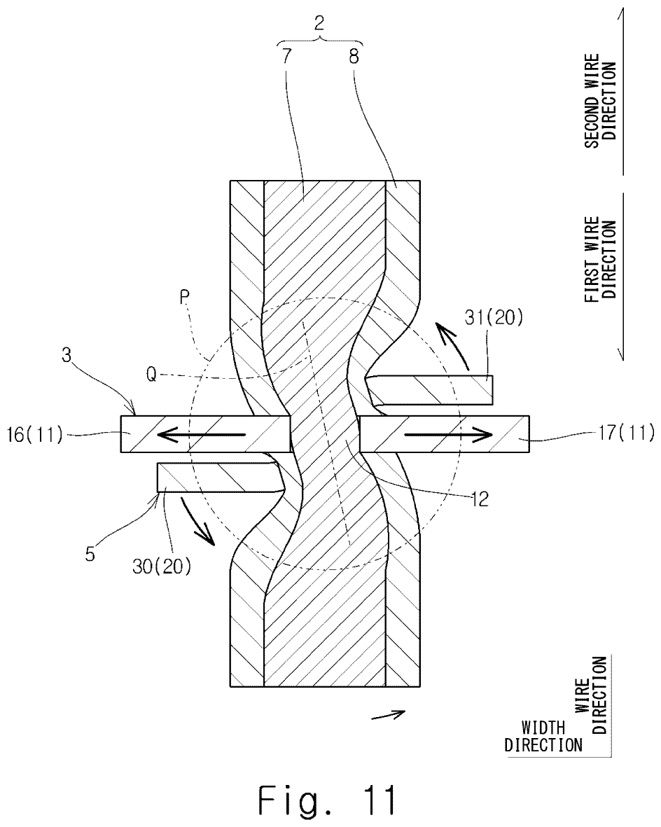

In addition, in the insulation displacement connector 1 according to this embodiment, the problem that the contact pressure of the core wire 7 of the wire 2 on the pair of IDC pieces 11 decreases due to displacement of the pair of IDC pieces 11 outward in the width direction by stress relaxation is reduced by another approach. To be specific, as shown in FIG. 10, the second pushing part 34 is inclined relative to the wire direction when viewed from above. In more detail, the second pushing part 34 projects in the first wire direction so as to come apart from the wire 2 when viewed from above. Thus, when the second IDC piece 17 is displaced outward in the width direction by stress relaxation, the second pushing part 34 slides over the second IDC piece 17 and is displaced in the second wire direction. As a result, as shown in FIG. 11, the second covering contact piece 31 rotates counter-clockwise when viewed from above, together with the second pushing part 34. Likewise, the first covering contact piece 30 rotates counter-clockwise when viewed from above, together with the first pushing part 33. This rotation causes the wire 2 to further rotate counter-clockwise in the proximity area P. By this local rotation of the wire 2, the contact pressure of the core wire 7 of the wire 2 on the pair of IDC pieces 11 increases. Consequently, even if the pair of IDC pieces 11 are displaced outward in the width direction by stress relaxation, the maximum value of the contact pressure of the core wire 7 of the wire 2 on the insulation displacement contact 3 does not largely decreases compared with that before displacement, which allows maintaining high contact reliability between the wire 2 and the insulation displacement contact 3.

An embodiment of the present disclosure is described above. The above-described embodiment has the following features.

As shown in FIG. 1, the insulation displacement connector 1 includes the insulation displacement contact 3 and the twisting member 5. The insulation displacement contact 3 includes the base 10 and the pair of IDC pieces 11 extending from the base 10. As shown in FIGS. 2 and 3, the wire 2 is press-fit into the wire press-fit slot 12 (slot) formed between the pair of IDC pieces 11, and thereby the core wire 7 of the wire 2 comes into contact with the pair of IDC pieces 11. As shown in FIG. 9, the twisting member 5 mates with the insulation displacement contact 3 and thereby twists the wire 2 so that the orientation of the line segment Q (the longitudinal direction of the core wire 7 of the wire 2 in the proximity area P) changes when viewed from above (when viewed along the press-fit direction of press-fitting the wire 2 into the wire press-fit slot 12 of the insulation displacement contact 3). This structure increases the contact pressure of the core wire 7 of the wire 2 on the pair of IDC pieces 11 and thereby achieves the insulation displacement connector 1 with high contact reliability.

As shown in FIG. 9, the twisting member 5 includes the pair of covering contact pieces 20 that come into contact with the covering 8 of the wire 2. The pair of covering contact pieces 20 are disposed on opposite sides to each other with the insulation displacement contact 3 interposed therebetween and also disposed on opposite sides to each other with the wire 2 interposed therebetween when viewed from above. In this structure, as the pair of covering contact pieces 20 come into contact with the covering 8 of the wire 2, a couple that twists the wire 2 acts on the wire 2. This allows the twisting member 5 to be achieved in a simple structure.

Further, the twisting member 5 further includes the coupling part 22 that couples the pair of covering contact pieces 20 and is inserted into the wire press-fit slot 12 of the insulation displacement contact 3. This structure prevents the wire 2 from being pulled upward out of the wire press-fit slot 12.

Further, as shown in FIG. 7, the twisting member 5 includes the pair of pushing parts 21 that push the pair of IDC pieces 11, respectively, so that the pair of IDC pieces 11 come closer to each other. This structure further increases the contact pressure of the core wire 7 of the wire 2 on the pair of IDC pieces 11.

Further, as shown in FIG. 7, the pair of pushing parts 21 are formed to project from the pair of covering contact pieces 20, respectively. This structure allows the pair of pushing parts 21 to come apart from each other with elastic deformation of the pair of covering contact pieces 20, which prevents an excessive increase in the contact pressure of the core wire 7 of the wire 2 on the pair of IDC pieces 11.

Further, as shown in FIG. 10, in the state where the twisting member 5 mates with the insulation displacement contact 3 when viewed from above, the pair of pushing parts 21 project to be apart from the wire 2. In this structure, when the pair of IDC pieces 11 come apart from each other by stress relaxation, the pair of pushing parts 21 slide over the pair of IDC pieces 11, respectively, and the pair of covering contact pieces 20 rotate about the coupling part 22 so as to be apart from the pair of IDC pieces 11 when viewed from above shown in FIG. 11. This rotation increases a couple that is generated when the pair of covering contact pieces 20 come into contact with the covering 8 of the wire 2. Thus, in this structure, even when the pair of IDC pieces 11 come apart from each other by stress relaxation, the contact pressure of the core wire 7 of the wire 2 on the pair of IDC pieces 11 is maintained.

Further, as shown in FIG. 7, the pair of pushing parts 21, the pair of covering contact pieces 20, and the coupling part 22 form an S-shape when viewed along the press-fit direction. This allows the twisting member 5 to be achieved in a simple structure.

Further, as shown in FIG. 7, the first pushing part 33, which is one of the pair of pushing parts 21, the first covering contact piece 30, which is one of the pair of covering contact pieces 20, the coupling part 22, the second covering contact piece 31, which is the other one of the pair of covering contact pieces 20, and the second pushing part 34, which is the other one of the pair of pushing parts 21, are linked together in this recited order.

Further, as shown in FIG. 6, the insulation displacement contact 3 includes the pair of contact-side lock parts 15. The twisting member 5 includes the pair of member-side lock parts 23. In the state where the twisting member 5 mates with the insulation displacement contact 3, the pair of contact-side lock parts 15 and the pair of member-side lock parts 23 are aligned in this recited order down below, which locks mating of the twisting member 5 and the insulation displacement contact 3. This structure allows the mating state of the twisting member 5 and the insulation displacement contact 3 to be maintained stably.

The above-described embodiment may be modified as follows, for example.

For example, in FIG. 9, the pair of covering contact pieces 20 may cut the covering 8 of the wire 2 and come into direct contact with the core wire 7 of the wire 2.

In FIG. 6, one of the pair of contact-side lock parts 15 may be omitted. Likewise, one of the pair of member-side lock parts 23 may be omitted. All of the pair of contact-side lock parts 15 and the pair of member-side lock parts 23 may be omitted.

As shown in FIG. 7, the twisting member 5 forms an S-shape when viewed from above in the above-described embodiment. However, the twisting member 5 may form an inverted S-shape when viewed from above. In this case, in the proximity area P shown in FIGS. 9 and 11, the wire 2 rotates clockwise when viewed from above.

Note that the insulation displacement connector 1 (IDC Connector) is a connector in which when the wire 2 is pushed into the insulation displacement contact 3 (IDC: Insulation Displacement Contact) without removing the covering 8 of the wire 2, the covering 8 of the wire 2 is locally cut and thereby the core wire 7 of the wire 2 becomes electrically continuous with the insulation displacement contact 3. The insulation displacement contact 3 is a terminal that is able to come into electrical contact with the core wire 7 of the wire 2 by locally cutting the covering 8 of the wire 2.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An insulation displacement connector comprising:
an insulation displacement contact including a base and a pair of insulation displacement pieces extending from the base, a wire being press-fit into a slot formed between the pair of insulation displacement pieces, and whereby a core wire of the wire comes into contact with the pair of insulation displacement pieces; and
a twisting member configured to mate with the insulation displacement contact and thereby twist the wire so that a longitudinal direction of the core wire of the wire changes when viewed along a press-fit direction of press-fitting the wire into the slot of the insulation displacement contact.

2. The insulation displacement connector according to claim 1, wherein
the twisting member includes a pair of covering contact pieces configured to come into contact with a covering of the wire, and
the pair of covering contact pieces are disposed in such a manner that the insulation displacement contact is interposed therebetween and also disposed in such a manner that the wire is interposed therebetween when viewed along the press-fit direction.

3. The insulation displacement connector according to claim 2, wherein the twisting member further includes a coupling part coupling the pair of covering contact pieces and configured to be inserted into the slot of the insulation displacement contact.

4. The insulation displacement connector according to claim 3, wherein the twisting member includes a pair of pushing parts configured to push the pair of insulation displacement pieces, respectively, so that the pair of insulation displacement pieces come closer to each other.

5. The insulation displacement connector according to claim 4, wherein the pair of pushing parts are formed to project from the pair of covering contact pieces, respectively.

6. The insulation displacement connector according to claim 5, wherein in the state where the twisting member mates with the insulation displacement contact, the pair of pushing parts project to be apart from the wire when viewed along the press-fit direction.

7. The insulation displacement connector according to claim 5, wherein the pair of pushing parts, the pair of covering contact pieces, and the coupling part form an S-shape or an inverted S-shape when viewed along the press-fit direction.

8. The insulation displacement connector according to claim 7, wherein one of the pair of pushing parts, one of the pair of covering contact pieces, the coupling part, another one of the pair of covering contact pieces, and another one of the pair of pushing parts are linked together in this recited order.

9. The insulation displacement connector according to claim 1, wherein
the insulation displacement contact includes a contact-side lock part,
the twisting member includes a member-side lock part, and
in the state where the twisting member mates with the insulation displacement contact, the contact-side lock part and the member-side lock part are aligned in this recited order in the press-fit direction, so that mating of the twisting member and the insulation displacement contact is locked.
